(19) United States
(12) Patent Application Publication
(10) Pub. No.: US 2009/0177741 A1
(43) Pub. Date: Jul. 9, 2009

(54) METHOD, SYSTEM AND DEVICE FOR SUBSCRIBING TO A SERVICE

(75) Inventor: Linyi Tian, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/404,086

(22) Filed: Mar. 13, 2009

Related U.S. Application Data
(63) Continuation of application No. PCT/CN2007/070366, filed on Jul. 26, 2007.

(30) Foreign Application Priority Data
Sep. 15, 2006 (CN) 200610062638.3

(51) Int. Cl. G06F 15/16

(52) U.S. Cl. 709/203

(57) ABSTRACT

The present invention provides a service subscription method including: transmitting, by a service user terminal, a request for subscribing to a service to a subscription management server, the request including a service ID; obtaining, by the subscription management server, permission to subscribe to the service for the service user terminal according to the request; performing, by the subscription management server, subscription of the service if the service user terminal has permission to subscribe to the service; otherwise, terminating the service subscription. Furthermore, the present invention also provides a service subscription system and a user terminal, an authorization management server and a subscription management server. With the present invention, it is possible to improve the security of the service subscription, especially to improve the security of subscribing services by teenagers as service users, which helps to prevent service subscriptions from illegal SPs.

### FIELD OF THE PRESENT INVENTION

The present invention relates to the field of mobile service, and more particularly, to a method, system and a corresponding device for subscribing to a service.

### BACKGROUND

With the wide deployment of mobile services, more and more organizations involve in the business of mobile Service Provider (SP). The multiple of SPs may provide the users with more and more enriched services, such as games, jokes, weather forecasts, instant message etc. Also the services are provided in different ways that some messages are sent in form of Short Message, some messages are sent in form of Multimedia Service and some messages are sent in form of Wireless Application Protocol (WAP) portal. Since there are lots of services and methods for providing the services, and the services and methods for providing the services involve the charging of the user and the profit division between SPs, it is necessary to efficiently manage the action of subscribing to a service by a user. Furthermore, some malicious SPs may try to induce users to subscribe to a service in various ways and charge the users in the name of “mistakenly subscribing to a service”. As a result, a great many users are left with bad user experiences or even suffer economic losses. Meanwhile, constant complaints from users make users lose interest in the mobile services, which may cause the SPs to maintain the services inconveniently and lose the service quality. Therefore, it is also necessary to effectively supervise the services provided by the SPs.

FIG. 1 is a flow chart of subscribing to a service in the prior art. As shown in FIG. 1, the method for subscribing to a service includes the following steps:

Step 101: A user terminal transmits a request for subscribing to a service to a subscription management server. That is, the user terminal may find services through a service portal or other means, and transmit the request for subscribing to the service to the subscription management server.

Step 102: The subscription management server transmits a service subscription notification to an application server according to the service subscription request transmitted from the user terminal, so as to inform the application server that the user terminal has subscribed to the service.

Step 103: The application server acknowledges the service subscribed by the user terminal and returns a subscription acknowledgement message to the subscription management server.

Step 104: The subscription management server forwards the subscription acknowledgement message transmitted from the application server to the user terminal.

FIG. 2 is a schematic diagram of a system for subscribing to a service in the prior art. As shown in FIG. 2, the system for subscribing to a service includes a user terminal, a subscription management server and an application server.

The user terminal is adapted to transmit a service subscription request and receive a subscription acknowledgement message.

The subscription management server includes an input unit 201, an output unit 203, a user subscription profile database 204 and a subscription processing unit 202. Here, the input unit 201 is adapted to receive the service subscription request transmitted by the user terminal and the subscription acknowledgement message transmitted by the application server, and to transmit the received service subscription request and subscription acknowledgement message to the subscription processing unit 202. The subscription processing unit 202 is adapted to determine, according to the service subscription request transmitted by the input unit 201 and information stored in the user subscription profile database 204, whether the service in the service subscription request has already been subscribed and whether the subscription parameters are met. If the service has not been subscribed and the subscription parameters are met, the service subscription request is then transmitted to the output unit 203. The subscription processing unit 202 is also adapted to modify or update data in the user subscription profile database 204 according to the subscription acknowledgement message transmitted by the input unit 201, and to transmit the subscription acknowledgement message to the output unit 203. The output unit 203 is adapted to transmit the service subscription request transmitted by the subscription processing unit 202 to the application server, or to transmit the subscription acknowledgement message to the user terminal. The user subscription profile database 204 is adapted to record a subscription profile of the user terminal and parameter comments of the subscribed service.

The application server is a service provider, which is located at the SP side and provides the user with service messages and synchronizes subscription information of the user with the subscription management server.

Nowadays, some SPs try to make profit by illegally providing ill-information, such as porn messages and pictures. In the present service subscription method, the service subscriber and the service user are generally the same, and the service subscription may be done after authentication in form of a short message or password. Meanwhile, a service user may only subscribe to a service for himself/herself, and the service may not be subscribed for the service user by an authorized party, nor the authorized party may limit the services subscribed by the service user. Therefore, with the increase of the popularity of the mobiles in the teenagers, it is necessary to enforce content protection, meanwhile to employ a safer service subscription method to ensure the information accessed by the teenagers safe and appropriate in order to prevent the teenagers from subscribing to the ill-information.

### SUMMARY

Embodiments of the present invention provide a service subscription method and system and a device therefor, which may solve the security issue in service subscription.

To achieve the above object, the technical solutions of the embodiments of the present invention are realized as follows.

A method for subscribing to a service includes:

receiving a request for subscribing to a service from a service user terminal, the request including a service ID;

obtaining permission to subscribe to the service for the service user terminal according to the request; and

performing subscription of the service if the service user terminal has permission to subscribe to the service.

An embodiment of the present invention also provides a method for subscribing to a service including:

receiving a request for subscribing to a service from a service subscription authorizer terminal, the request including an ID of a service user terminal and a service ID;

obtaining permission to subscribe to the service for the service user terminal according to the ID of the service user terminal in the request; and

perform subscription of the service if the service user terminal has permission to subscribe to the service.

An embodiment of the present invention provides a system for subscribing to a service which includes a user terminal, a subscription management server and an authorization management server;

the user terminal is adapted to transmit a request for subscribing to a service to the subscription management server, the request including an ID of a service user terminal and a service ID; and

the subscription management server is adapted to obtain permission to subscribe to the service for the user terminal corresponding to the ID of the service user terminal through the authorization management server, and if the user terminal has the permission to subscribe to the service, the subscription management server performs subscription of the service.

In the embodiments of the present invention, the service user terminal may authorize the service subscription authorizer terminal so that the service subscription authorizer terminal may limit the service user terminal's right for subscribing to services. It is possible to improve the security of service subscription, especially improve the security of service subscription by teenagers as service users, which prevents subscribing to a service from illegal SPs. Meanwhile, the service subscription authorizer terminal may subscribe to services for the service user terminal, which solves the problem of having to subscribe to a service by the service user terminal in the prior art and improves the user experiences of the service user.

### BRIEF DESCRIPTION OF THE DRAWINGS

FIG. 1 is a flow chart of a method for subscribing to a service in the prior art;

FIG. 2 is a schematic diagram of a system for subscribing to a service in the prior art;

FIG. 3 is a schematic diagram of a system for subscribing to a service according to an embodiment of the present invention;

FIG. 4 is a schematic diagram of the structure of an authorization management server according to an embodiment of the present invention;

FIG. 5 is a flow chart of a method for subscribing to a service according to an embodiment of the present invention;

FIG. 6 is a flow chart of a process of authorizing a service subscription authorizer terminal according to an embodiment of the present invention;

FIG. 7 is a flow chart of a process of authorizing a service subscription authorizer terminal according to another embodiment of the present invention;

FIG. 8 is a flow chart of a process of setting permissions for a service user terminal to subscribe to a service in an authorization management server according to an embodiment of the present invention;

FIG. 9 is a flow chart of a process of subscribing to a service by initiating a service subscription request by a service user terminal according to an embodiment of the present invention; and

FIG. 10 is a flow chart of a process of subscribing to a service by initiating a service subscription request by a service subscription authorizer terminal according to an embodiment of the present invention.

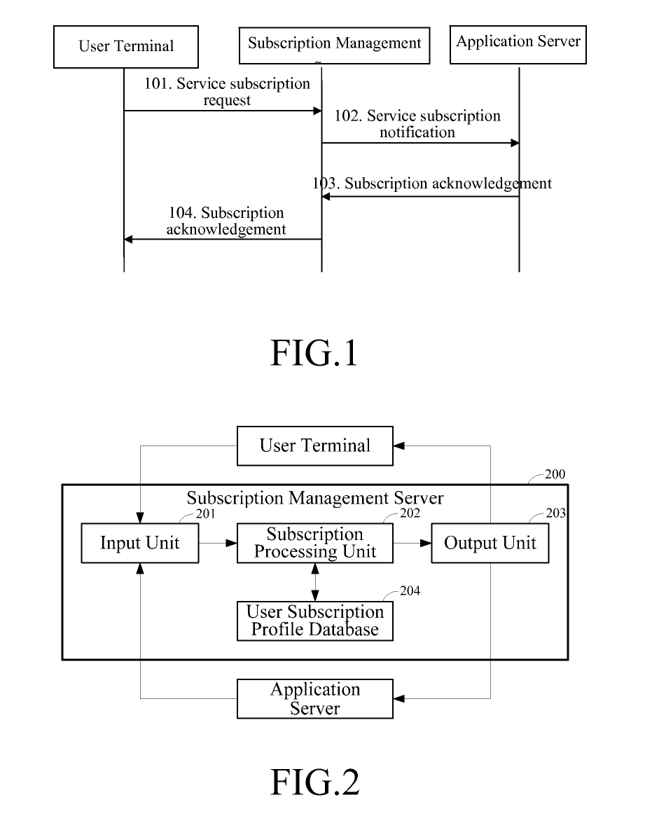

### DETAILED DESCRIPTION

In the following, detailed implementations of the present invention will be further described with reference to the accompanying figures and embodiments.

An embodiment of the present invention provides a method and a system as well as a corresponding device for subscribing to a service. In the method, the user terminal may be a service user terminal or a service subscription authorizer terminal. A certain user terminal may become the service subscription authorizer terminal of a service user terminal via registration etc. The service subscription authorizer terminal may subscribe to a service for the corresponding service user terminal or limit the service subscribed by the service user terminal. As a result, it improves the security of service subscription, more particularly improves the security of service subscription made by teenagers, and avoids the harmful or unsafe service subscription provided by illegal SPs.

In an embodiment of the present invention, the user terminal may only be used by one user at a time. Thus, in the following description, the user terminal and the user using the user terminal share the same ID for simplicity. For example, when the user terminal is a service user terminal, the ID of the service user terminal is also the ID of the service user. When the user terminal is a service subscription authorizer terminal, the ID of the service subscription authorizer terminal is also the ID of the service subscription authorizer.

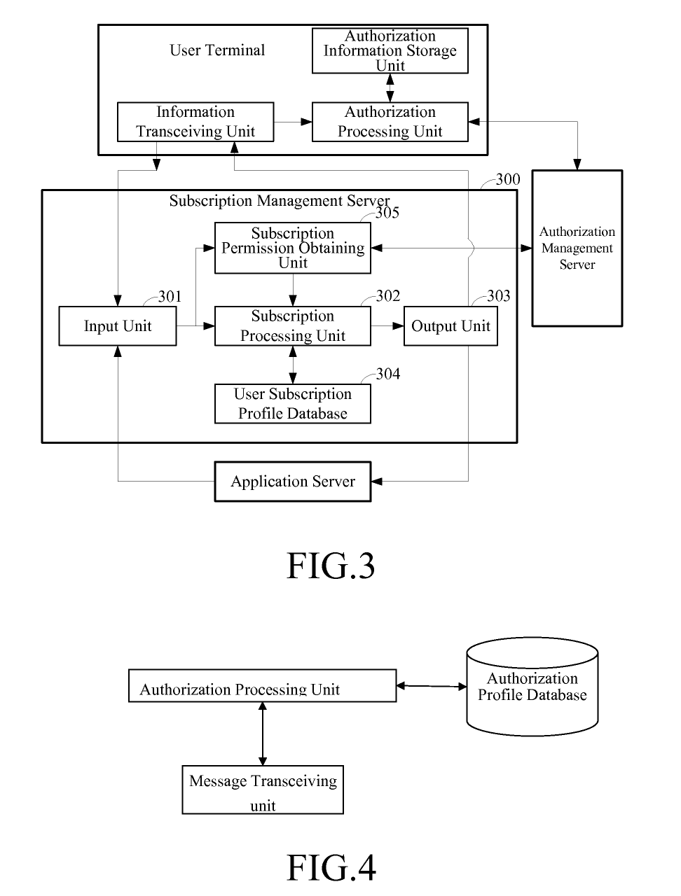

FIG. 3 is a schematic diagram of a system for subscribing to a service according to an embodiment of the present invention. As shown in FIG. 3, the service subscription system according to the embodiment of the present invention includes a user terminal, a subscription management server, an application server and an authorization management server.

Both the subscription management server and the authorization management server are logical structures and they may be a single physical device, which performs the functions of the subscription management server and the authorization management server.

Here, the user terminal may be a service user terminal or a service subscription authorizer terminal. The user terminal includes an information transceiving unit, an authorization processing unit and an authorization information storage unit. The information transceiving unit is adapted to transmit a service subscription request to the subscription management server or transmit an authorization request to the authorization processing unit, and to receive a subscription acknowledge message. The authorization information storage unit is adapted to save authorization information. The authorization processing unit is adapted to transmit an authorization request transmitted by the information transceiving unit to the authorization management server, and to modify or update the authorization information saved in the authorization information storage unit according to the message returned by the authorization management server.

The subscription management server 300 includes an input unit 301, an output unit 303, a user subscription profile database 304, a subscription processing unit 302 and a subscription permission obtaining unit 305. Here, the input unit 301 is adapted to receive the service subscription request transmitted by the user terminal and the subscription acknowledgement message transmitted by the application server and to transmit the received service subscription request and subscription acknowledgement message to the subscription processing unit 302. The output unit 303 is adapted to transmit the service subscription request transmitted by the subscription processing unit 302 to the application server, or to transmit the subscription acknowledgement message to the user terminal. The user subscription profile database 304 is adapted to record the subscription profile of the user terminal and parameter comments of the subscribed service. The subscription processing unit 302 is adapted to determine whether the service in the service subscription request has already been subscribed and whether the service meets subscription parameters, according to the service subscription request transmitted by the input unit 301, information saved in the user subscription profile database 304 and authentication response information transmitted by the subscription permission obtaining unit 305. If the service has not been subscribed and the subscription parameters are met, the service subscription request is then transmitted to the output unit 303. The subscription processing unit 302 is also adapted to modify or update data in the user subscription profile database 304 according to the subscription acknowledgement message transmitted by the input unit 301 and to transmit the subscription acknowledgement message to the output unit 303. The subscription permission obtaining unit 305 is adapted to transmit authentication request message to the authorization management server according to the service subscription request transmitted by the input unit 301, and to obtain from the authorization management server the authentication response information of whether it has permission to subscribe to the service, and transmit the authentication response information to the subscription processing unit 302.

The application server is a service provider, which is located at the SP side and provides the user with service messages and synchronizes subscription information of the user with the subscription management server.

The authorization management server, the detailed structure of which is shown in FIG. 4, includes an authorization profile database. The authorization profile database is adapted to record a relationship between a user and an authorized user and to record an authorization result, such as the corresponding permission and the authorization level. The authorization management server further includes an authorization processing unit. The authorization processing unit is adapted to maintain data in the authorization profile database, process the authorization request from the user terminal and respond to the authentication request message from the subscription management server. The authorization management server further includes a message transceiving unit. The message transceiving unit is adapted to transmit and receive messages and to interact with the user terminal and the authorization management server.

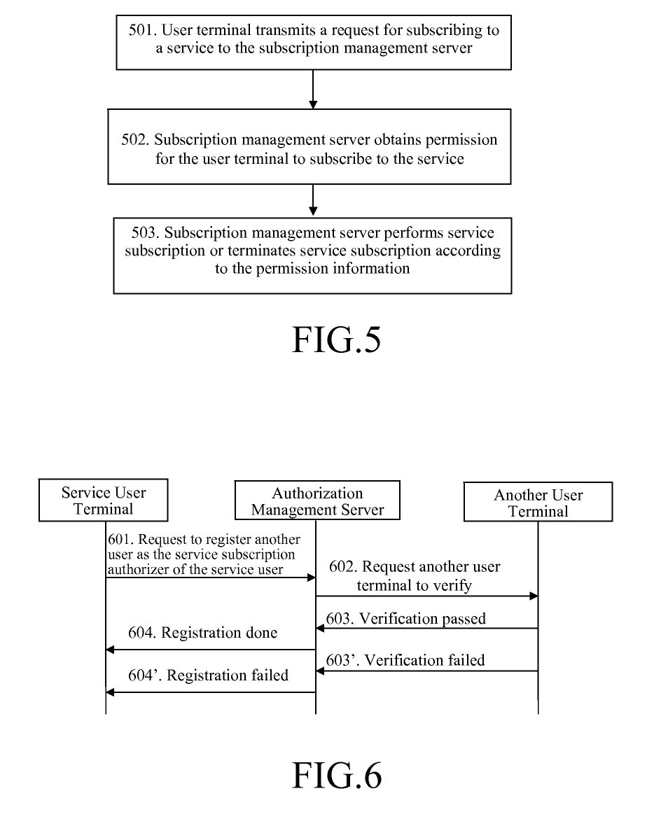

FIG. 5 is a flow chart of a method for subscribing to a service according to an embodiment of the present invention. As shown in FIG. 5, the method according to the embodiment of the present invention includes the following steps:

Step 501: The user terminal transmits a service subscription request to the subscription management server. Here, the user terminal may be a service user terminal or a service subscription authorizer terminal. The request includes an ID of the service user and a service ID.

Step 502: The subscription management server obtains permission to subscribe to the service for the user terminal according to the ID of the service user.

Step 503: If the user terminal has the permission to subscribe to the service, the subscription management server performs the service subscription according the permission; otherwise, the service subscription is terminated.

Here, before executing of step 501, another user should be registered so as to be the service subscription authorizer terminal of the service user terminal, and the another user authorizes the service subscribed by the service user terminal after becoming the service subscription authorizer terminal, and the authorization information is recorded by the authorization management server. Naturally, the authorization information may also be recorded in other documents, such as in an Extensible Markup Language (XML) file, whose address may be recorded by the authorization management server.

FIG. 6 is a flow chart of a process for authorizing a service subscription authorizer terminal according to an embodiment of the present invention. As shown in FIG. 6, the process for authorizing a service subscription authorizer terminal according to the embodiment of the present invention includes the following steps:

Step 601: A user A (i.e., the service user terminal) transmits a registration request message to the authorization management server so as to request to register a user B (i.e., the service subscription authorizer terminal) as an authoring user of the user A, or to modify the authorization permission of the user B with respect to user A. The registration request message includes ID of the user B (such as a mobile number) and the corresponding description of the authorization information. The registration request message may further include the user ID of at least one authorized user (e.g. the user A).

Step 602: The authorization management server transmits a message to the user B to inform the user B of his permission granted by the user A and ask the user B to verify the permission. If the user B verifies to be the service subscription authorizer of the user A, step 603 is executed; otherwise, step 603′ is executed.

Step 603: The user B returns information indicating verification done to the authorization management server. The information indicating verification done may further include services authorized by the user B to the user A, such as, services that the user A may subscribe to freely, services that the user A may not subscribe to, and services that the user A may subscribe to only with permission of the user B. Upon receiving the verification information from the user B, the authorization management server maintains information of the authorization profile database so as to finish the registration of the user B, and step 604 is executed.

Step 604: A registration done message is transmitted to the user A to inform that the requested registration has been done and the process is ended. This step is optional.

Step 603′: If the user B refuses or does not verify, then the user B returns a verification failed message to the authorization management server. The message may further include reason for the failure of the verification, such as, the user A does not give enough authorization to the user B, the user B does not wish to accept the authorization etc. Next, step 604′ is executed.

Step 604′: The authorization management server transmits a registration failed message to the user A to inform that the requested registration is failed. If the message returned by the user B further includes the reason for the failure, then the reason is also included in the message.

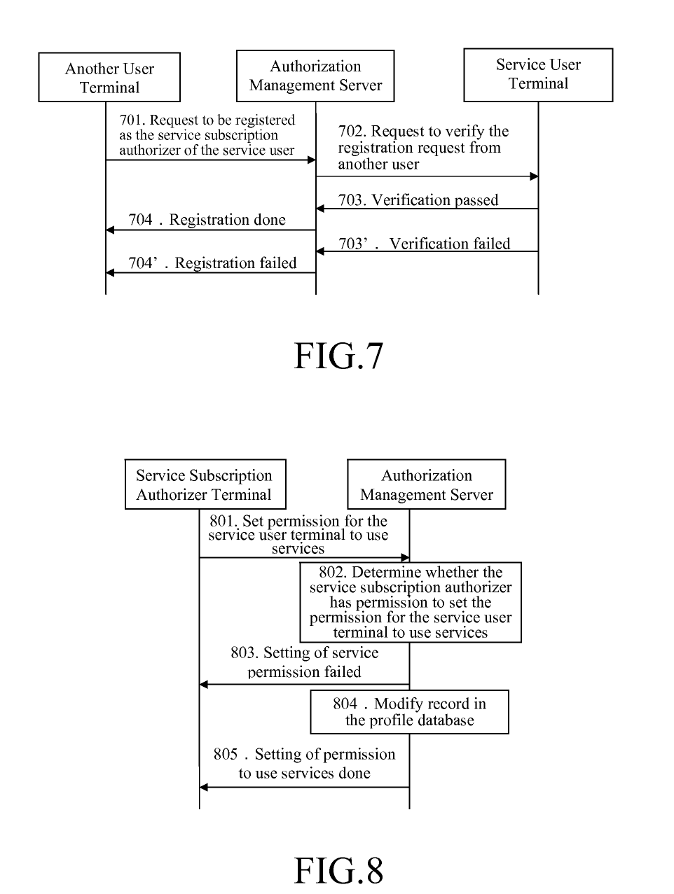

Furthermore, an embodiment of the present invention also provides a method for authorizing a service subscription authorizer terminal. FIG. 7 is a flow chart of a process for authorizing a service subscription authorizer terminal according to the embodiment of the present invention. As shown in FIG. 7, the authorization process includes the following steps:

Step 701: The user B transmits a message to the authorization management server to request to be the service subscription authorizer terminal of the user A (i.e., the service user terminal). The message includes ID of the user A (such as a mobile number) and information on the management permission. Alternatively, the user B requests the authorization management server to modify its service subscription management permission over the user A, such as, which services the user A may subscribe to freely, which services the user A may not subscribe to, and which services the user A may subscribe to only with the permission of the user B. The message may include the user ID of at least one of the user A or B, as well as information about the authorized permission.

Step 702: The authorization management server transmits a message to the user A to inform that the user B requests to be registered as the service subscription authorizer of the user A. The message may further include management or subscription permission for the service used by the user A granted by the user B and ask the user A to verify. If the user A verifies that the user B is the service subscription authorizer of the user A, step 703 is executed; otherwise, step 703′ is executed.

Step 703: The user A transmits a verification passed message indicating acceptance of the registration to the authorization management server. Upon receiving the verification passed message from the user A, the authorization management server maintains information of the authorization profile database and finishes authorizing the user B, and step 704 is executed.

Step 704: The authorization management server transmits a registration done message to the user B to inform that the registration is done. This step is optional and the process may be ended without the authorization management server informing the user B that the authorization is done.

Step 703′: The user A transmits a verification failed message indicating declining of the registration to the authorization management server, and the process proceeds to step 704′. Here, the message may further include reason for the failure of the verification.

Step 704′: The authorization management server transmits a registration failed message to the user B. If the message received by the authorization management server further includes the reason for the failure of the verification, then the reason is also included in the message transmitted by the authorization management server to the user B.

Here, in the above two methods for registering the user B as the service subscription authorizer of the user A, the format of the message with which the user A or the user B requests the authorization management server to authorize is as shown in the following table:

| ID | type | Comments |
|---|---|---|
| MsgType | string | Message type |
| TransactionID | string | Message number |
| User_ID | user_id_schema | User ID, i.e., ID of the service |
| | | user terminal |
| AUC_User_ID | subcriber_id_schema | Authorized user ID, i.e., ID |
| | | of the service authorized |
| | | terminal |
| Action List | Action schema | Including the following |
| | | authorization actions: |
| | | Full control |
| | | Subscription of new service |
| | | Modify service subscription |
| | | parameter |
| | | Cancel subscribed service |

Here, the authorization management server may record the authorization information directly in the authorization profile database, or may save the authorization information in another file (e.g., the authorization information may be described using policy realized by XML) with only the address of the file recorded in authorization profile database.

Naturally, when the user B is registered as the service subscription authorizer of the user A, the permission of using services may be not set for the user A, which may be set separately in the authorization management server when the registration is done.

FIG. 8 is a flow chart of a process for setting a service user terminal's permission for subscribing to a service in an authorization management server according to an embodiment of the present invention. As shown in FIG. 8, the process for setting the service user terminal's permission for subscribing to the service in the authorization management server includes the following steps:

Step 801: The authorized user B (i.e., the service subscription authorizer terminal) transmits to the authorization management server a request for modifying the permission of using or subscribing to a service for the user A (i.e., the service user terminal). The request includes ID of the user B, ID of the user A and a service ID. The permission may include for example, which services the user A may subscribe to freely, which services the user A may not subscribe to, and which services the user A may subscribe to with permission of the user B.

Step 802: Upon receiving the request, the authorization management server queries the authorization profile database and determines whether the user B has permission to set the permission of using or subscribing to services for the user A. In the above permission setting for the user B, if the permission that the user B has over the user A is full control, the user B may set the permission of using services or subscribing to new services for the user A; if the permission that the user B has over the user A is only to control the subscription of new services, the user B may not modify parameters of the services that the user A has already subscribed to, nor can the user B terminate services that the user A has already subscribed to; if the permission that the user B has over the user A is only to modify service subscription parameters, the user B can not decide whether the user A can subscribe to a new service; and if the permission that the user B has over the user A is to cancel the subscribed services, the user B can only cancel the services subscribed by the user A, but can not control whether the user A may subscribe to a new service

The authorization management server determines whether the user B may set permission of using services for the user A. If the user B may set permission of using services for the user A, then step 803 is executed; while if the user B may not set permission of using services for the user A, a message indicating the permission setting failed is returned.

Step 803: The authorization management server modifies a record of permission for using services by the user A in the authorization profile database, or modifies a record of permission for using services by the user A in the XML document according to the link address recorded in the authorization profile database.

Here, the format of the information saved in the authorization profile database is as shown in the following table:

| | ID of service | | |
|---|---|---|---|
| | subscription | Control permission of | |
| ID of service | authorizer | service subscription | Service subscription |
| user terminal | terminal | authorizer terminal | permission of user |
| UserA | UserB | Full control | MobileSP1.com |
| | | | accessible |
| | | | MobileSP2.com |
| | | | unaccessible |
| | UserC | Full control | |
| UserD | UserE | . . . | |
| UserF | UserE | Cancel subscription | |
| | | only | |

Step 804: The authorization management server informs the user B that the modification to permission of service subscription for the user A is done. Certainly, the authorization management server may also inform the user A that permission of service subscription has been modified.

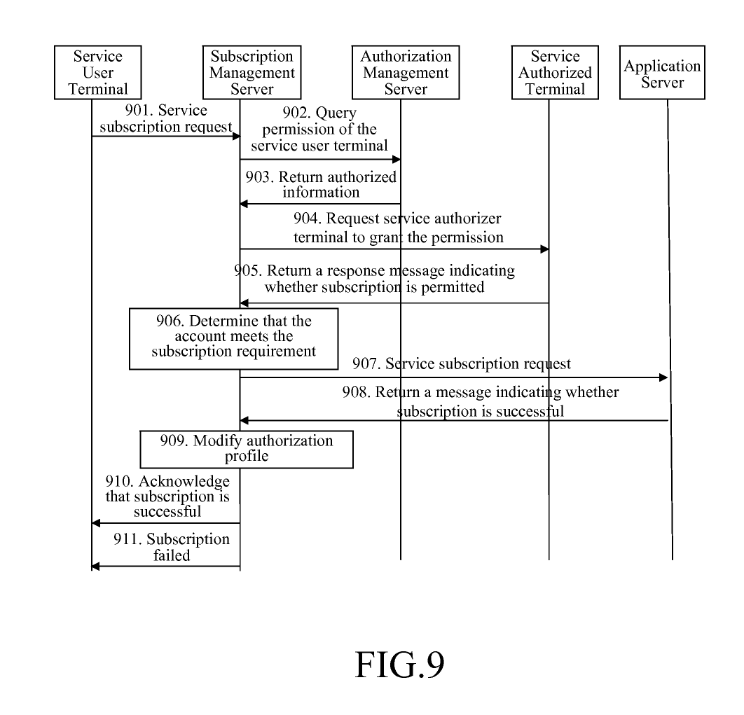

After the service user terminal has been authorized with permission to subscribe to a service by the service subscription authorizer terminal, the service user terminal may initiate a service subscription request to subscribe to a service. FIG. 9 illustrates a flow chart of a process for the service user terminal initiating a service subscription request to subscribe to a service according to an embodiment of the present invention. As shown in FIG. 9, the process includes the following steps:

Step 901: The user A transmits a service subscription request message to the subscription management server so as to request to subscribe to or cancel a new service or modify parameters of a subscribed service. The service subscription request message may include a service ID of the service to be subscribed to or cancelled and an ID of the service user (i.e., the ID of the user A). The message may also include the ID of the service subscriber, account information used to subscribe to the service (i.e., information about the account that is paying for subscribing to the service), as well as the service subscription parameters.

Step 902: The subscription management server transmits a query request to the authorization management server to query whether the service user terminal in the service subscription request received by the subscription management server has the permission to subscribe to the service corresponding to the service ID in the service subscription request. The query request transmitted from the subscription management server to the authorization management server may include the ID of the service user terminal and a service subscription ID.

The authorization management server queries the related authorization information of the user A in the profile database and obtains the ID of the service subscription authorizer terminal and the permission information.

If the service subscription authorizer terminal has performed permission setting to subscribe to services for the service user terminal in the authorization management server as shown in FIG. 8 when the service subscription authorizer terminal is authorized. The authorization management server may decide whether the service user terminal has the permission to subscribe to the service according to the record in the authorization profile database. If the service to be subscribed by the service user terminal is a service that may be subscribed directly, step 903 is executed to return service authorized information, and then step 906 is executed right following step 903. If the service to be subscribed to by the service user terminal is a service not allowed to be subscribed, step 911 is executed right following step 903 to return a message indicating that the service user terminal is not allowed to subscribe to the service and the service subscription is failed. If the service to be subscribed to by the service user terminal is a service that needs the permission of the service subscription authorizer terminal, step 904 is executed following step 903.

Step 903: A service authorized message is returned. The message may include information of whether the service user terminal has the permission to subscribe to the service or the service may be subscribed to only with the permission of the service subscription authorizer terminal.

Step 904: The subscription management server transmits an authorization request message to the service subscription authorizer terminal according to the ID of the service subscription authorizer terminal in the service authorized message, so as to request the service subscription authorizer terminal to authorize the service user terminal to subscribe to the service. The authorization request message carries the ID of the service user terminal and the ID of the service to be subscribed.

Step 905: The service subscription authorizer terminal determines whether the service user terminal has permission to subscribe to the service according to the ID of the service user terminal and the ID of the service to be subscribed in the authorization request message. If the service subscription authorizer terminal permits the service user terminal to subscribe to the service, the service subscription authorizer terminal returns a success message to the subscription management server; otherwise, a message indicating that the service user terminal does not have permission to subscribe to the service is returned. The subscription management server receives the message from the service subscription authorizer terminal and parses the message. If it is a success message returned, step 906 is executed; otherwise, step 911 is executed.

Step 906: The subscription management server determines whether the account of the service user terminal meets the requirement for service subscription for this time. If the requirement is not met, step 911 is executed. If the requirement is met, step 907 is executed.

Step 907: The subscription management server looks for the corresponding application server according to the ID of the service to be subscribed to and transmits the service subscription request message to the application server.

Step 908: Upon receiving the service subscription request message from the subscription management server, the application server determines whether the application server is able to meet the subscription from the service user terminal, according to the subscription request message and the parameters of the service to be subscribed to, and returns a message indicating whether the subscription is successful. If the subscription is successful, step 909 is executed; otherwise, step 911 is executed.

Step 909: The subscription management server modifies the authorization profile database and records the result of subscribing to the service by the service user terminal when receiving a subscription done response message from the application server.

Step 910: The subscription management server transmits a message to the service user terminal acknowledging that the subscription is successful, and the process is ended.

Step 911: The subscription management server transmits a message indicating the subscription failure as well as the reason for the failure to the service user terminal, and the process is ended here.

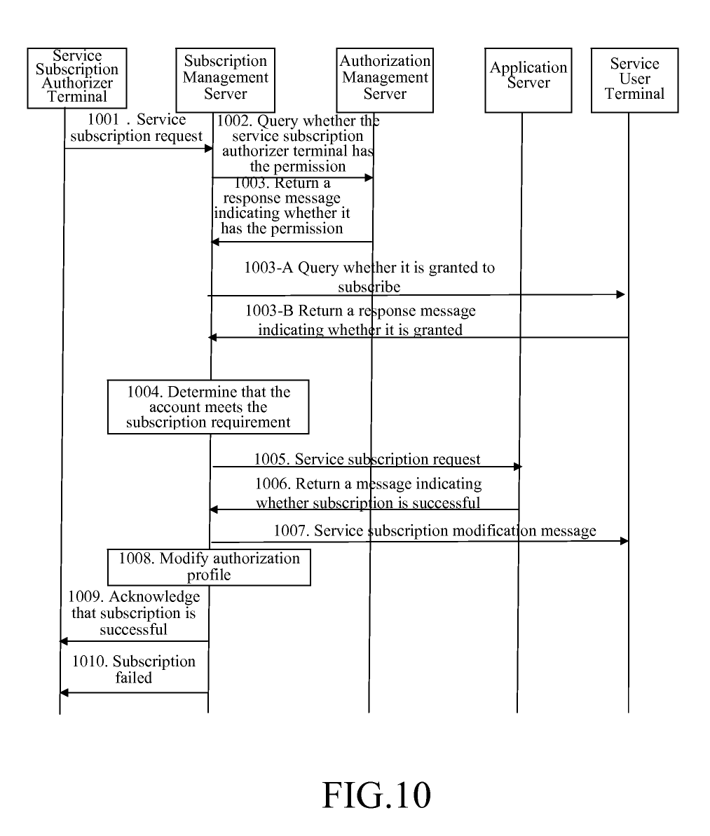

After the service user terminal has been authorized with permission to subscribe to a service by the service subscription authorizer terminal, the service subscription authorizer terminal may also subscribe to a service for the service user terminal by initiating a service subscription request. FIG. 10 illustrates a flow chart of a process for the service subscription authorizer terminal initiating a service subscription request to subscribe to a service according to an embodiment of the present invention. As shown in FIG. 10, the detailed flow includes the following steps:

Step 1001: The service subscription authorizer terminal transmits the service subscription request to the subscription management server to subscribe to a service for the service user terminal. The service subscription request includes the service ID and the ID of the service user terminal. The service subscription request may also include the ID of the service subscription authorizer terminal and account information used to subscribe to the service, as well as the service subscription parameters.

Step 1002: The subscription management server transmits a query request to the authorization management server to query whether the service subscription authorizer terminal in the service subscription request received by the subscription management server has the permission to subscribe to the service corresponding to the service ID in the service subscription request for the service user terminal. The query request transmitted from the subscription management server to the authorization management server includes the ID of the service user terminal, ID of the service to be subscribed, and the ID of the service subscription authorizer terminal.

Step 1003: The authorization management server queries the authorization information of the service user terminal in the authorization profile database and determines whether the service subscription authorizer terminal has the permission to subscribe to the service for the service user terminal and returns a response message indicating whether the service subscription authorizer terminal has the permission. If the authorization management server determines that the service subscription authorizer terminal has the permission to subscribe to the service for the service user terminal, it returns a response message indicating that that service subscription authorizer terminal has the permission and step 1004 is executed. Otherwise, a response message indicating that the service subscription authorizer terminal does not have the permission is returned and step 1010 is executed, or alternatively steps 1003-A and 1003-B are executed.

Step 1003-A: The subscription management server transmits a query message to the service user to enquiry whether the service subscription authorizer terminal is allowed to subscribe to the service. The query message includes the service ID and the ID of the service subscription authorizer.

Step 1003-B: The service user returns a response message indicating whether to authorize the service subscription authorizer terminal according to the query message. If the service user allows the service to be subscribed to, step 1004 is executed; otherwise the service user returns a response message indicating that the subscription is not allowed, and step 1010 is executed.

Step 1004: The subscription management server determines whether the account of the service user terminal meets requirement for subscribing to the service for this time. If it does not meet the requirement for subscribing to the service, step 1010 is executed; if it meets the requirement for subscribing to the service, step 1005 is executed.

Step 1005: The subscription management server looks for the corresponding application server according to the ID of the service to be subscribed, and transmits the service subscription request message to the application server.

Step 1006: Upon receiving the service subscription request message from the subscription management server, the application server determines whether the application server meet the subscription from the service user terminal, according to the subscription request message and the parameters of the service to be subscribed to, and returns a message indicating whether the subscription is successful. If the subscription is successful, step 1007 is executed; otherwise, step 1010 is executed.

Step 1007: The subscription management server transmits a service subscription modification message to the service user terminal. Certainly, this step is optional, and the subscription management server may not transmit the service subscription modification message to the service user terminal.

Step 1008: The subscription management server modifies the service subscription information of the service user terminal in the authorization profile database. This step may be executed in parallel with step 1007 without a strict order.

Step 1009: The subscription management server transmits a message acknowledging that the subscription is successful to the service subscription authorizer terminal and the process is ended here.

Step 1010: The subscription management server transmits a message indicating the subscription failure as well as the reason for the failure to the service subscription authorizer terminal, and the process is ended here.

Here, the format of the service subscription message initiated by the service user terminal or service subscription authorizer terminal is as follows:

| Definition | Type | Comments |
|---|---|---|
| MsgType | string | Message type |
| TransactionID | string | Message number |
| Version | string | Version of interfacing message |
| Send_Address | address_info_schema | Address of the sender |
| Dest_Address | address_info_schema | Address of the receiver |
| User_ID | user_id_schema | |
| Subscriber_ID | user_id_schema | |
| Account_ID | acount_schema | ID of the charging account |
| SPID | string | SP ID |
| SPServiceID | string | Service ID in SP |
| AccessMode | Integer | Access mode for the service |
| | | 1: WEB |
| | | 2: WAP |
| | | 3: SMS |
| FeatureStr | binary | Service subscription parameter |

To further describe the technical solutions of the present invention, the following two embodiments will be elaborated in detail.

### Embodiment One

John bought a mobile telephone for his son Michael recently. Michael is just 14 years old and still at middle school. With the development of mobile services, the mobile may not only access Internet, but also may be provided with various services by the SPs for the mobile users. Since John concerns that Michael may access some harmful service contents which may have undesirable effect on Michael, he hopes to have full control over the services which may be subscribed to by Michael.

John may send a short message to the authorization management server to obtain the service control permission over Michael according to the method for authorizing the service subscription authorizer terminal as shown in FIG. 7. The short message sent by John may include the following contents:

| Data Item | Value | Comments |
|---|---|---|
| User ID | 13456789000 | Michael's mobile number |
| ID of the | 1331234**** | John's mobile number |
| authorizer user | | |
| Permission | Full control | To have full control over Michael's |
| identifier | | service |

Upon receiving the message, the authorization management server transmits a message to Michael to inform him that John wants to control the services which may be subscribed by Michael, and ask whether Michael will accept it. If Michael returns an acknowledgement message, the authorization management server will modify data and save the authorization relationship.

After obtaining the above permission, when John finds that a cartoon service provided through multimedia messages by a SP is very interesting and matches with Michael's hobby, John may transmit a subscription message to the subscription server to subscribe to the cartoon service for Michael. The subscription message includes the following contents:

| Data item | Value | Comments |
|---|---|---|
| User | 13456789000 | Michael's mobile number |
| Subscriber ID | 1331234**** | John's mobile number |
| ServiceID | 0205 | service ID of the service to be |
| | | subscribed |
| Charging user | 1331234**** | John's account will be charged |
| Subscription | xxxx | Description of the subscription |
| parameters | | parameters |

Upon obtaining the subscription message, the subscription server queries the authorization management server about whether John has the permission to subscribe to the service for Michael. When the authorization management server responds with an acknowledgement message, the subscription management server finishes the service subscription and tells John the subscription is successful. Moreover, the service management server may also inform Michael that John has subscribed to a new service for him.

Meanwhile, if Michael finds through a classmate's recommendation that another SP (say SP2) provides a good foreign language learning service, which provides not only the latest foreign language news but also on-line help, he may transmit a subscription message to the subscription server to subscribe to the service. The subscription message may include the following contents:

| Data item | Value | Comments |
|---|---|---|
| User | 13456789000 | Michael's mobile number |
| Subscriber ID | 1331234**** | John's mobile number |
| ServiceID | 0235 | Service ID of the service to be |
| | | subscribed |
| Charging user | 1331234**** | John's account will be charged |
| Subscription | xxxx | Description of the subscription |
| parameters | | parameters |

Upon receiving the subscription message from Michael, the subscription server queries the authorization management server and finds that John has full control over Michal's service subscription permission. Then the subscription server transmits a message to John to ask him whether John will permit Michael to subscribe to this service. If John finds after research that the contents provided by the service are good for Michael's study, he will agree with the service subscription from Michael. The subscription server will then subscribe to the service for Michael and inform John and Michael that the service is successfully subscribed to.

### Embodiment Two

It is assumed that John is the boss of a company and he has hundreds of employees in his company. An employee Michael is taken as an example for the following description. Michael may transmit an authorization message to the authorization management server to authorize John with permission that John may only subscribe to a service for Michael, but may not cancel or modify a service for Michael. The authorization message includes at least the following contents:

| Data item | Value | Comments |
|---|---|---|
| User ID | 13456789000 | Michael's mobile number |
| Authorizing user ID | 1331234**** | John's mobile number |
| Permission ID | Subscribe | Subscribing only |

Upon receiving the authorization message from Michael, the authorization management server transmits a query message to John to ask John whether he will accept Michael's request. If John replies with a message indicating consent, the authorization management server then acknowledges the authorization relationship between Michael and John.

After the above authorization, if John finds a mobile SP (say MobileSP1) may provide digital newspaper service to mobile users, that is, the mobile SP may provide news including text, pictures and videos to the mobile users through Multimedia Message System (MMS), John may transmit a subscription request message to the subscription management server to request to subscribe to the service for his employees in case that John wishes to provide a benefit to his employees, that is, let his employees be capable of reading news on the underground train when getting to or getting off the work. The subscription request message includes at least the following information:

| Data item | Value | Comments |
|---|---|---|
| User1 | 13456789000 | Michael's mobile number |
| . . . | | |
| Usern | 13456789999 | Mobile number of employee N |
| Subscriber ID | 13312345678 | John's mobile number |
| ServiceID | 0205 | Service ID of the service to be |
| | | subscribed |
| Charging user | 13312345678 | John's account will be charged |
| Subscription | xxxx | Description of the subscription |
| parameters | | parameters |

Upon receiving the subscription request, the subscription server queries the authorization management server about whether John has the permission to subscribe to the services for these users. After receiving a confirmation, the subscription server subscribes to the service for these users and informs John that the service subscription is successful. Meanwhile, the subscription server will inform the users such as Michael that John has subscribed to a new service for them and John will take charge for the service.

Furthermore, if Michael bought a car after the service has been subscribed for a while and thus he no longer takes the underground to get to or get off work, Michael may decide to cancel the service so as not to be disturbed while driving. At this time, Michael may transmit a message to cancel the service to the subscription server. The subscription server finds that the user may cancel the service himself and then will cancel the service and inform Michael that the service is cancelled.

It can be seen from the above embodiments that the service subscription authorizer terminal may limit the service user terminal's permission to subscribe to services by the service user may authorizing the service subscription authorizer, so as to improve the security of the service subscription, especially to improve the security of subscribing services by teenagers as service users, which helps to prevent service subscriptions from illegal SPs.

The above is only preferred embodiments of the present invention, which is not intended to limit the scope of the present invention. Any modification, equivalent substitution and improvement within the spirit and scope of the present invention are intended to be included in the scope of the present invention.

1. A method for subscribing to a service, comprising:
receiving a request for subscribing to a service from a service user terminal, the request comprising a service ID;
obtaining permission to subscribe to the service for the service user terminal according to the request; and
performing subscription of the service if the service user terminal has permission to subscribe to the service.

2. The method of claim 1, wherein the obtaining permission to subscribe to the service for the service user terminal further comprises:
obtaining the permission to subscribe to the service for the service user terminal through an authorization management server according to an ID of the service user terminal; or
after obtaining information of a service subscription authorizer terminal through an authorization management server, obtaining the permission to subscribe to the service for the service user terminal from the service subscription authorizer terminal according to the information of the service subscription authorizer terminal.

3. The method of claim 2, wherein before receiving the request for subscribing to the service from the service user terminal, the method further comprises:
registering a first user terminal different from the service user terminal as the service subscription authorizer terminal of the service user terminal.

4. The method of claim 3, wherein registering the first user terminal as the service subscription authorizer terminal of the service user terminal further comprises:
receiving, by the authorization management server, a request for registering the first user terminal as the service subscription authorizer terminal of the service user terminal transmitted from the service user terminal, the request comprising the ID of the service user terminal and an ID of the first user terminal;
informing, by the authorization management server, the first user terminal of the request according to the ID of the first user terminal;
receiving, by the authorization management server, a message acknowledging the registration returned by the first user terminal; and
recoding, by the authorization management server, information about the registration.

5. The method of claim 4, wherein the message acknowledging the registration returned by the first user terminal further carries information for setting permission to subscribe to the service for the service user terminal;
the method further comprises recording, by the authorization management server, the information about the permission.

6. The method of claim 3, wherein after registering the first user terminal as the service subscription authorizer terminal of the service user terminal, the method further comprises:
setting permission to subscribe to the service for the service user terminal in the authorization management server;
and recording, by the authorization management server, information about the permission.

7. The method of claim 1, wherein the request for subscribing to the service received from the service user terminal further comprises parameters of the service.

8. The method of claim 1, wherein the method further comprises:
notifying, by the subscription management server, an application server that the service user terminal subscribes to the service if the service user terminal has permission to subscribe to the service;
receiving, by the subscription management server, a response message returned by the application server that determines whether the subscription is successful according to the notification;
and informing, by the subscription management server, the service user terminal of a subscription result according to the response message from the application server.

9. A method for subscribing to a service, comprising:
receiving a request for subscribing to a service from a service subscription authorizer terminal, the request comprising an ID of a service user terminal and a service ID;
obtaining permission to subscribe to the service for the service user terminal according to the ID of the service user terminal in the request; and
perform subscription of the service if the service user terminal has permission to subscribe to the service.

10. The method of claim 9, wherein the obtaining permission to subscribe to the service for the service user terminal further comprises:
obtaining, by a subscription management server, the permission to subscribe to the service for the service user terminal according to the ID of the service user terminal; or
after obtaining information of the service subscription authorizer terminal through an authorization management server, obtaining, by a subscription management server, permission to subscribe to the service for the service user terminal from the service subscription authorizer terminal according to the information of the service subscription authorizer terminal.

11. The method of claim 9, wherein before receiving the request for subscribing to the service from the service subscription authorizer terminal, the method further comprises:
registering a second user terminal different from the service user terminal as the service subscription authorizer terminal of the service user terminal.

12. The method of claim 11, wherein registering the second user terminal as the service subscription authorizer terminal of the service user terminal further comprises:
receiving, by the authorization management server, a request for registering the second user terminal as the service subscription authorizer terminal of the service user terminal transmitted from the second user terminal, wherein the request comprises the ID of the service user terminal and an ID of the second user terminal;
transmitting, by the authorization management server, the request to the service user terminal according to the ID of the service user terminal;
receiving, by the authorization management server, a message acknowledging registration of the second user terminal as the service subscription authorizer terminal from the service user terminal; and
recoding, by the authorization management server, information about the registration.

13. The method of claim 12, wherein the request for registering the second user terminal as the service subscription authorizer terminal of the service user terminal transmitted from the second user terminal and received by the authorization management server further comprises information for setting permission to subscribe to the service for the service user terminal;
the service subscription method further comprises receiving, by the authorization management server, a message acknowledging the permission set by the service subscription authorizer terminal from the service user terminal; and recording, by the authorization management server, information about the permission.

14. The method of claim 12, wherein after registering the second user terminal as the service subscription authorizer terminal of the service user terminal, the method further comprises setting permission to subscribe to the service for the service user terminal in the authorization management server; and recording, by the authorization management server, information about the permission.

15. The method of claim 9, wherein the request for subscribing to the service received from the service subscription authorizer terminal further comprises parameters of the service.

16. The method of claim 9, wherein the service subscription method further comprises: notifying an application server that the service user terminal subscribes a service if the service subscription authorizer terminal has permission to subscribe to the service; receiving a response message returned by the application server that determines whether the subscription is successful according to the notification; and informing the service subscription authorizer terminal of a subscription result according to the response message from the application server.

17. A system for subscribing to a service, comprising a user terminal, a subscription management server and an authorization management server; wherein
the user terminal is adapted to transmit a request for subscribing to a service to the subscription management server, the request comprising an ID of a service user terminal and a service ID; and
the subscription management server is adapted to obtain permission to subscribe to the service for the user terminal corresponding to the ID of the service user terminal through the authorization management server, and if the user terminal has the permission to subscribe to the service, the subscription management server performs subscription of the service.

18. The system of claim 17, wherein the user terminal is a service subscription authorizer terminal or a service user terminal;
the service user terminal is adapted to register a user terminal different from the service user terminal as the service subscription authorizer terminal through the authorization management server; or a user terminal different from the service user terminal requests to be registered as the service subscription authorizer terminal of the service user terminal through the authorization management server; and
the authorization server is adapted to record information about the registration.

19. The system of claim 18, wherein the authorization management server is further adapted to query the service subscription authorizer terminal about the permission to subscribe to the service for the service user terminal.

20. The system of claim 18, wherein the service subscription authorizer terminal is adapted to authorize the service user terminal through the authorization management server; the authorization management server is further adapted to record address of information about the authorization for the service user terminal.
